(19) United States
(12) Patent Application Publication
(10) Pub. No.: US 2010/0048190 A1
(43) Pub. Date: Feb. 25, 2010

(54) MOBILE TERMINAL EQUIPPED WITH MULTIPLE DISPLAY MODULES AND METHOD OF CONTROLLING OPERATION OF THE MOBILE TERMINAL

(75) Inventors: Jun Serk Park, Seoul (KR); Na Ri Lee, Seoul (KR); Min Hun Kang, Seoul (KR); Kyoung Joung Kim, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/508,851

(22) Filed: Jul. 24, 2009

(30) Foreign Application Priority Data
Aug. 22, 2008 (KR) 10-2008-0082466

(51) Int. Cl. H04M 3/42; H04B 1/38; G06F 3/041

(52) U.S. Cl. 455/415; 455/566; 345/173

(57) ABSTRACT

Provided is a method of controlling the operation of a mobile terminal equipped with first and second display modules provided on first and second surfaces, respectively, of a main body of the mobile terminal. The method includes choosing an operation menu; displaying a first image corresponding to the chosen operation menu on a first display module; and displaying a second image corresponding to the chosen operation menu on a second display module. Therefore, it is possible to effectively control the operation of the mobile terminal using the first and second display modules.

### CROSS-REFERENCE TO RELATED APPLICATIONS

This application claims priority to the filing date of Korean Patent Application No. 10-2008-0082466, filed on Aug. 22, 2008 in the Korean Intellectual Property Office, the content of which is incorporated by reference herein in its entirety.

### BACKGROUND

1. Field of the Disclosure

The present disclosure relates to a mobile terminal capable of controlling various operations using a plurality of display modules having different properties and a method of controlling the operation of the mobile terminal.

2. Description of the Related Art

Mobile terminals are portable devices, which can provide users with various services such as a voice calling service, a video calling service, an information input/output service, and a data storage service. As the types of services provided by mobile terminals diversify, an increasing number of mobile terminals have been equipped with various complicated functions such as capturing photos or moving pictures, playing music files or moving image files, providing game programs, receiving broadcast programs and providing wireless internet services. These mobile terminals have thus evolved into multimedia players.

Various attempts have been made to realize such complicated functions as hardware devices or software programs. For example, various user interface (UI) environments, in which users are allowed to easily search for and choose desired functions, have been developed. In addition, the demand for various designs for mobile terminals such as a double-sided liquid crystal display (LCD) or a full touch screen has steadily grown due to a growing tendency of considering mobile terminals as personal items that can represent personal individuality.

However, there is a restriction in allocating sufficient space for a UI (such as a display device or a keypad) of a mobile terminal without compromising the mobility and the portability of a mobile terminal. In addition, mobile terminals are generally required to provide high power efficiency. Therefore, it is desirable to develop ways to control the operation of a mobile terminal using a UI capable of improving the spatial efficiency and the power efficiency of a mobile terminal.

### SUMMARY

A mobile terminal and a method of controlling the operation of the mobile terminal in which various operations performed by the mobile terminal can be effectively controlled using two display modules, for example, a touch screen display and an electronic paper (e-paper) display.

According to an aspect of the present invention, there is provided a method of controlling a mobile terminal, the method including selecting a menu operation at the mobile terminal and selecting between a first display module provided on a first side of the mobile terminal and a second display module provided on a second side of the mobile terminal to display an image corresponding to the selected menu operation.

According to another aspect of the present invention, there is provided a mobile terminal including a first display module provided on a first side of the mobile terminal, a second display module provided on a second side of the mobile terminal, and a controller configured to select between the first display module and the second display module to display a first image corresponding to a selected operation.

According to another aspect of the present invention, there is provided a method of controlling a mobile terminal provided with multiple display modules, the method including receiving an incoming call, detecting information about the incoming call, detecting whether the incoming call belongs to a first group of callers or a second group of callers according to the detected information, selecting a first display module to display a first image corresponding to the detected information when the first group is detected, and selecting a second display module to display a second image corresponding to the detected information when the second group is detected.

According to another aspect of the present invention, there is provided a method of controlling a mobile terminal provided with multiple display modules, the method including receiving an incoming call, detecting information about the incoming call, detecting whether the incoming call requests to connect to a first phone number or to a second phone number of the mobile terminal, and selecting a first display module to display a first image corresponding to the information when the first phone number is requested and the second display module to display a second image corresponding to the information when the second phone number is requested.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

The above and other features and advantages of the present disclosure will become more apparent by describing in detail preferred embodiments thereof with reference to the attached drawings in which:

FIG. 1 illustrates a block diagram of a mobile terminal according to an exemplary embodiment of the present disclosure;

FIG. 2 illustrates a front perspective view of the mobile terminal shown in FIG. 1;

FIG. 3 illustrates a rear perspective view of the mobile terminal shown in FIG. 1;

FIG. 4 illustrates a flowchart of a method of controlling the operation of a mobile terminal according to a first exemplary embodiment of the present disclosure;

FIG. 5 illustrates a flowchart of a method of controlling the operation of a mobile terminal according to a second exemplary embodiment of the present disclosure;

FIG. 6 illustrates a flowchart of a method of controlling the operation of a mobile terminal according to a third exemplary embodiment of the present disclosure; and

FIGS. 7 to 15 illustrate diagrams for explaining the methods of the first through third exemplary embodiments.

Features, elements, and aspects of the disclosure that are referenced by the same numerals in different figures represent the same, equivalent, or similar features, elements, or aspects, in accordance with one or more embodiments.

### DETAILED DESCRIPTION

In the following, numerous specific details are set forth to provide a thorough description of various embodiments of the claimed subject matter. Certain embodiments may be practiced without these specific details or with some variations in detail. In some instances, certain features are described in less detail so as not to obscure other aspects of the disclosed embodiments. The level of detail associated with each of the elements or features should not be construed to qualify the novelty or importance of one feature over the others. The term ‘mobile terminal’ described in this disclosure can include a mobile phone, a smart phone, a laptop book computer, a digital broadcast receiver, a personal digital assistant (PDA), a portable multimedia player (PMP), a navigation device.

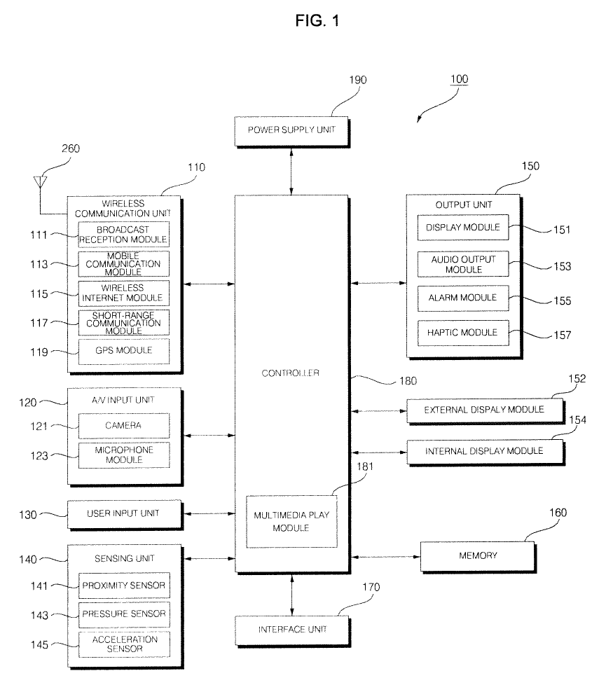

FIG. 1 illustrates a block diagram of a mobile terminal 100 according to an embodiment of the present disclosure. Referring to FIG. 1, the mobile terminal 100 may include a wireless communication unit 110, an audio/video (A/V) input unit 120, a user input unit 130, a sensing unit 140, an output unit 150, a memory 160, an interface unit 170, a controller 180, and a power supply unit 190.

Two or more of the wireless communication unit 110, the A/V input unit 120, the user input unit 130, the sensing unit 140, the output unit 150, the memory 160, the interface unit 170, the controller 180, and the power supply unit 190 may be incorporated into a single unit. Alternately, some of the wireless communication unit 110, the A/V input unit 120, the user input unit 130, the sensing unit 140, the output unit 150, the memory 160, the interface unit 170, the controller 180, and the power supply unit 190 may be divided into two or more smaller units.

The wireless communication unit 110 may include a broadcast reception module 111, a mobile communication module 113, a wireless Internet module 115, a short-range communication module 117, and a global positioning system (GPS) module 119.

The broadcast reception module 111 receives either a broadcast signal or broadcast-related information from an external broadcast management server through a broadcast channel. Examples of the broadcast channel include a satellite channel and a terrestrial channel. The broadcast signal and the broadcast-related information received by the broadcast reception module 111 may be stored in the memory 160.

The broadcast management server may be a server which generates either broadcast signals or broadcast-related information for transmission. Alternatively, the broadcast management server may receive and transmit previously-generated broadcast signals and broadcast-related information.

Examples of the broadcast-related information include broadcast channel information, broadcast program information and broadcast service provider information. Examples of the broadcast signal include a TV broadcast signal, a radio broadcast signal, a data broadcast signal, or a combination of a data broadcast signal and either a TV broadcast signal or a radio broadcast signal.

The broadcast-related information may be provided to the mobile terminal 100 through a mobile communication network. In this case, the broadcast-related information may be received by the mobile communication module 113, rather than by the broadcast reception module 111. The broadcast-related information may come in various forms, for example, electronic program guide (EPG) of digital multimedia broadcasting (DMB) or electronic service guide (ESG) of digital video broadcast-handheld (DVB-H).

The broadcast reception module 111 may receive the broadcast signal using various broadcasting systems such as digital multimedia broadcasting-terrestrial (DMB-T), digital multimedia broadcasting-satellite (DMB-S), media forward link only (MediaFLO), DVB-H, and integrated services digital broadcast-terrestrial (ISDB-T). In addition, the broadcast reception module 111 may be configured for other types of broadcasting systems in addition to those set forth herein.

The mobile communication module 113 transmits and receives wireless signals from at least one of a base station, an external terminal, and a server through a mobile communication network. The wireless signals may include various types of data according to whether the mobile terminal 100 transmits or receives voice call signals, video call signals, or text/multimedia messages.

The wireless Internet module 115 may be a module for wirelessly accessing the Internet. The wireless Internet module 115 may be embedded in the mobile terminal 100 or may be installed in an external device. The wireless Internet module 115 may use various wireless Internet techniques such as wireless fidelity (WiFi), wireless broadband (Wibro), world interoperability for microwave access (Wimax) or high-speed downlink Packet Access (HSDPA).

The short-range communication module 117 may be a module for short-range communication. The short-range communication module 117 may use various short-range communication techniques such as Bluetooth®, radio frequency identification (RFID), infrared data association (IrDA), ultra wideband (UWB), and ZigBee®.

The GPS module 119 may receive position information from a plurality of GPS satellites.

The A/V input unit 120 may be used to receive audio signals or video signals. The A/V input unit 120 may include a camera 121 and a microphone module 123.

The camera 121 processes various image frames such as still images or moving images captured by an image sensor during a video call mode or an image capturing mode. The image frames processed by the camera 121 may be displayed by a display module 151.

The image frames processed by the camera 121 may be stored in the memory 160 or may be transmitted outside the mobile terminal 100 through the wireless communication unit 110. The mobile terminal 100 may include two or more cameras 121.

The microphone module 123 receives external sound signals during a call mode, a recording mode, or a voice recognition mode with the use of a microphone and converts the sound signals into electrical sound data. In the call mode, the mobile communication module 113 may convert the electrical sound data into data that can be readily transmitted to a mobile communication base station and then output the data obtained by the conversion. The microphone module 123 may use various noise removal algorithms to remove noise that may be generated during the reception of external sound signals.

The user input unit 130 generates key input data based on user input for controlling the operation of the mobile terminal 100. The user input unit 130 may be implemented as a keypad, a dome switch, a touch pad (either static pressure or constant electricity), a jog wheel, or a jog switch. In particular, when the user input unit 130 is implemented as a touch pad and forms a mutual layer structure along with the display module 151, the user input unit 130 and the display module 151 may be collectively referred to as a touch screen.

The sensing unit 140 determines a current state of the mobile terminal 100 such as whether the mobile terminal 100 is opened or closed, the position of the mobile terminal 100 and whether the mobile terminal 100 is placed in contact with a user. Additionally, and the sensing unit 140 generates a sensing signal for controlling the operation of the mobile terminal 100.

For example, when the mobile terminal 100 is a slider-type mobile phone, the sensing unit 140 may determine whether the mobile terminal 100 is opened or closed. In addition, the sensing unit 140 may determine whether the mobile terminal 100 is powered by the power supply unit 190 and whether the interface unit 170 is connected to an external device. The sensing unit 140 may include a proximity sensor 141, a pressure sensor 143, and an acceleration sensor 145.

The proximity sensor 141 may determine whether there is an entity nearby and approaching the mobile terminal 100 without any mechanical contact with the entity. More specifically, the proximity sensor 141 may detect an entity that is nearby and approaching by detecting a change in an alternating magnetic field or the rate of change of static capacitance. The sensing unit 140 may include two or more proximity sensors 141.

The pressure sensor 143 may determine whether pressure is being applied to the mobile terminal 100 and may detect the magnitude of pressure applied to the mobile terminal 100. The pressure sensor 143 may be installed in a portion of the mobile terminal 100 in which the detection of pressure is desirable.

For example, the pressure sensor 143 may be installed in the display module 151. In this case, the display module 151 may differentiate a typical touch input from a pressure touch input, which is generated by applying greater pressure than that used to generate a typical touch input, based on a signal output by the pressure sensor 143. In addition, it is possible to determine the magnitude of pressure applied to the display module 151 upon receiving a pressure touch input based on the signal output by the pressure sensor 143.

Two or three acceleration sensors 145 representing different axial directions may be installed in the mobile terminal 100. Alternatively, one acceleration sensor 145 representing a Z axis may be installed in the mobile terminal 100.

Acceleration sensors are a type of device for converting an acceleration variation into an electric signal. With recent developments in micro-electromechanical system (MEMS) technology, acceleration sensors have been widely used in various products for various purposes.

For example an acceleration sensor 145 may be installed in an airbag system for an automobile and may thus be used to detect collisions. Alternatively, an acceleration sensor 145 may be used as an input device for a computer game and may sense the motion of the human hand during a computer game.

The output unit 150 may output audio signals, video signals and alarm signals. The output unit 150 may include the display module 151, an audio output module 153, an alarm module 155, and a haptic module 157.

The display module 151 may display various information processed by the mobile terminal 100. For example, when the mobile terminal 100 is in a call mode, the display module 151 may display a user interface (UI) or a graphic user interface (GUI) for making or receiving a call. When the mobile terminal 100 is in a video call mode or an image capturing mode, the display module 151 may display a UI or a GUI for capturing or receiving images.

When the display module 151 and the user input unit 130 form a mutual layer structure and are thus implemented as a touch screen, the display module 151 may be used as an output device and as an input device. When the display module 151 is implemented as a touch screen, the display module 151 may also include a touch screen panel and a touch screen panel controller.

The touch screen panel is a transparent panel attached to the exterior of the mobile terminal 100 and may be connected to an internal bus of the mobile terminal 100. The touch screen panel keeps monitoring whether the touch screen panel is being touched by a user.

Once a touch input to the touch screen panel is detected, the touch screen panel transmits a number of signals corresponding to the touch input to the touch screen panel controller. The touch screen panel controller processes the signals transmitted by the touch screen panel, and transmits the processed signals to the control unit 180. Then, the control unit 180 determines whether a touch input has been generated and which part of the touch screen panel has been touched based on the processed signals transmitted by the touch screen panel controller.

The display module 151 may include electronic paper (e-paper). E-paper is a type of reflective display technology and can provide as high resolution as ordinary ink on paper, wide viewing angles, and excellent visual properties.

E-paper may be implemented on any type of substrate such as a plastic, metallic or paper substrate and may maintain an image displayed thereon even when power is cut off. In addition, e-paper may be able to reduce the power consumption of the mobile terminal 100 because it does not require a backlight assembly.

The display module 151 may be implemented as e-paper by using electrostatic-charged hemispherical twist balls, using electrophoretic deposition, or using microcapsules. Forms of electronic media such as these and any similar technologies will be collectively referred to as “electronic paper” throughout the remainder of this disclosure.

Electronic paper technologies generally require that power be applied to generate the electric field for creating or altering the image shown on the visual display. The generated image may be static until another electric field is applied. This reduced, intermittent power requirement is beneficial for use in disclosed embodiments discussed below. As will be appreciated by one of skill in the art, media incorporating material that can be magnetically manipulated in similar manner as the electronic paper described above can also be used as the updateable visual display as discussed herein.

As described above, when the display module 151 and the user input unit 130 form a mutual layer structure and are thus implemented as a touch screen, the display module 151 may be used not as an output device and as an input device. The display module 151 may include at least one of a liquid crystal display (LCD), a thin film transistor (TFT)-LCD, an organic light-emitting diode (OLED), a flexible display, and a three-dimensional (3D) display.

The mobile terminal 100 may include two or more display modules 151. For example, the mobile terminal 100 may include an external display module 152 and an internal display module 154.

The audio output module 153 may output audio data received by the wireless communication unit 110 during a call reception mode, a call mode, a recording mode, a voice recognition mode, or a broadcast reception mode or may output audio data present in the memory 160. In addition, the audio output module 153 may output various sound signals associated with the functions of the mobile terminal 100 such as receiving a call or a message. The audio output module 153 may include a speaker and a buzzer.

The alarm module 155 may output an alarm signal indicating the occurrence of an event in the mobile terminal 100. Examples of the event include receiving a call signal, receiving a message, and receiving a key signal. Examples of the alarm signal output by the alarm module 155 include an audio signal, a video signal and a vibration signal.

The alarm module 155 may output a signal upon receiving a call signal or a message. In addition, the alarm module 155 may receive a key signal and may output a signal as feedback to the key signal.

Once a signal is output by the alarm module 155, the user may recognize that an event has occurred. A signal for notifying the user of the occurrence of an event may be output by the display module 151 or the audio output module 153.

The haptic module 157 may provide various haptic effects (such as vibrations) that can be perceived by the user. When the haptic module 157 generates vibration as a haptic effect, the intensity and the pattern of vibration generated by the haptic module 157 may be altered in various manners. The mobile terminal 100 may include two or more haptic modules 157.

The haptic module 157 may synthesize different vibration effects and may output the result of the synthesization. Alternatively, the haptic module 157 may sequentially output different vibration effects.

The haptic module 157 may provide various haptic effects, other than vibration, such as a haptic effect obtained using a pin array that moves perpendicularly to a contact skin surface, a haptic effect obtained by injecting or sucking in air through an injection hole or a suction hole, a haptic effect obtained by giving a stimulus to the surface of the skin, a haptic effect obtained through contact with an electrode, a haptic effect obtained using an electrostatic force, and a haptic effect obtained by realizing the sense of heat or cold using a device capable of absorbing heat or generating heat. The haptic module 157 may be configured to enable the user to recognize a haptic effect using the kinesthetic sense of the fingers or the arms.

The memory 160 may store various programs for the operation of the controller 180. In addition, the memory 160 may temporarily store various data such as a phonebook, messages, still images, or moving images.

The memory 160 may include at least one of a flash memory type storage medium, a hard disk type storage medium, a multimedia card micro type storage medium, a card type memory (e.g., a secure digital (SD) or extreme digital (XD) memory), a random access memory (RAM), and a read-only memory (ROM). The mobile terminal 100 may operate a web storage, which performs the functions of the memory 160 on the internet.

The interface unit 170 may interface with an external device that can be connected to the mobile terminal 100. The interface unit 170 may be a wired/wireless headset, an external battery charger, a wired/wireless data port, a card socket to receive, for example, a memory card, a subscriber identification module (SIM) card or a user identity module (UIM) card, an audio input/output (I/O) terminal, a video I/O terminal, or an earphone. The interface unit 170 may receive data from an external device or may be powered by an external device. The interface unit 170 may transmit data provided by an external device to other components in the mobile terminal 100 or may transmit data provided by other components in the mobile terminal 100 to an external device.

When the mobile terminal 100 is connected to an external cradle, power may be supplied from the external cradle to the mobile terminal through the interface unit 170. Various command signals may be transmitted from the external cradle to the mobile terminal through the interface unit 170.

The controller 180 may control the general operation of the mobile terminal 100. For example, the controller 180 may perform various control operations regarding making/receiving a voice call, transmitting/receiving data, or making/receiving a video call.

The controller 180 may include a multimedia play module 181, which plays multimedia data. The multimedia play module 181 may be implemented as a hardware device and may be installed in the controller 180. Alternatively, the multimedia play module 181 may be implemented as a software program.

The power supply unit 190 is supplied with power by an external power source or an internal power source and supplies power to other components in the mobile terminal 100.

The mobile terminal 100 may include a wired/wireless communication system and a satellite-based communication system. The mobile terminal 100 may be configured to be able to operate in a communication system transmitting data as frames or packets.

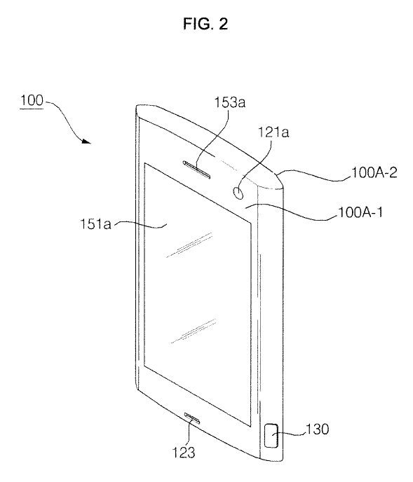

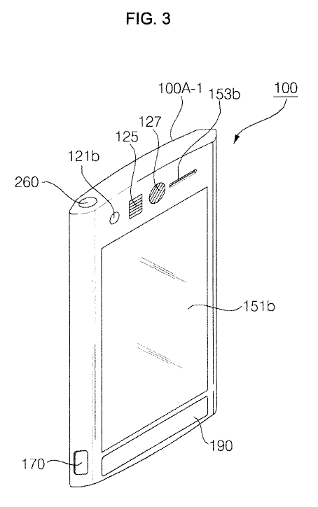

The exterior of the mobile terminal 100 will hereinafter be described in detail with reference to FIGS. 2 and 3. For convenience, assume that the mobile terminal 100 is a slider-type mobile phone. However, the present disclosure is not restricted to a slider-type mobile phone. Rather, the present disclosure can be applied to various mobile phones, other than a slider-type mobile phone.

FIG. 2 illustrates a front perspective view of the mobile terminal 100 shown in FIG. 1. Referring to FIG. 2, the exterior of the mobile terminal 100 may be defined by a front case 100A-1 and a rear case 100A-2. Various electronic products may be installed in the empty space between the front case 100A-1 and the rear case 100A-2. At least one intermediate case may be additionally disposed between the front case 100A-1 and the rear case 100A-2.

The front case 100A-1 and the rear case 100A-2 may be formed of a synthetic resin through injection molding. Alternatively, the front case 100A-1 and the rear case 100A-2 may be formed of a metal such as stainless steel (STS) or titanium (Ti).

A first display module 151a, a first audio output module 153a, a first camera 121a and a user input unit 130 may be disposed in the front case 100A-1. The first display module 151a and a second display module 151b may be LCDs, OLEDs or e-paper which can visualize information.

A touch pad is configured to overlap the first and second display modules 151a and 151b thus realize a layer structure. The first and second display modules 151a and 151b may serve as touch screens. Therefore, it is possible for a user to input information to the first and second display modules 151a and 151b simply by touching the first and second display modules 151a and 151b.

The first audio output module 153a may be implemented as a receiver or a speaker. The first camera 121a may be configured to capture a still image or a moving image of a user. The microphone 123 may be configured to receive voice of the user or other audio.

The user input unit 130 may adopt various manipulation methods as long as it can offer tactile feedback to a user. For example, the user input unit 130 may be implemented as a dome switch or a touch pad which receives a command or information upon being pushed or touched by a user. Alternatively, the user input unit 130 may be implemented as a wheel, a jog dial, or a joystick.

The user input unit 130 may allow a user to input commands, such as “start”, “end”, and “scroll.” Additionally, the user input unit 130 allows the user to choose an operating mode and may serve as a hot key for activating certain functions of the mobile terminal 100.

FIG. 3 illustrates a rear perspective view of the mobile terminal 100 shown in FIG. 1. Referring to FIG. 3, an interface unit 170 may be disposed on the rear case 100A-2. A second camera 121b may be disposed at an end of the rear case 100A-2.

The second camera 121b may have a different photographing direction from that of the first camera 121a shown in FIG. 2. In addition, the number of pixels of the second camera 121b may be different from the number of pixels of the first camera 121a.

For example, the first camera 121a may be used to capture an image of a user's face and then readily transmit the captured image during a video call. Hence, a low-resolution lens may be used for the first camera 121a.

The second camera 121b may be used to capture an image of an ordinary object. Given that images captured by the second camera 121b generally do not need to be transmitted, a high-resolution lens may be used for the second camera 121b.

A camera flash device 125 and a mirror device 127 may be disposed near the second camera 121b. The user may look in the mirror device 127 for taking a self photograph. The camera flash device 125 may illuminate an object when the second camera 121b captures an image of the object.

A second audio output module 153b may be additionally provided on the rear case 100A-2. The second audio output module 153b may realize a stereo function along with the first audio output module 153a. The second audio output module 153b may also be used during a speaker-phone mode.

An antenna 260 for receiving a broadcast signal may be disposed on one end of the rear case 100A-2. The antenna 260 may be configured to pull out of the rear case 100A-2. Alternatively, the antenna 260 may be disposed on the front case 100A-1.

The power supply unit 190 may be disposed on the rear case 100A-2. The power supply unit 190 may be a rechargeable battery and may be coupled to the rear case 100A-2 to be non-permanently attached to the rear case 100A-2.

The second camera 121b is illustrated in FIG. 3 as being disposed in the rear case 100A-2, but the present disclosure is not restricted to this. For example, the first camera 121a may rotate to provide the photographing direction of the second camera 121b. Thus, the second camera 121b may be optional.

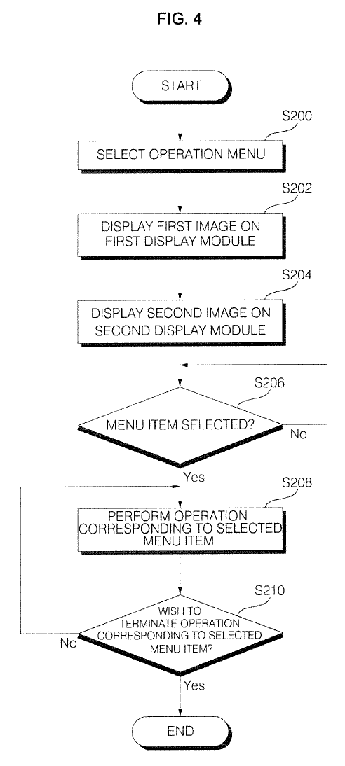

FIG. 4 illustrates a flowchart of a method of controlling the operation of a mobile terminal according to a first exemplary embodiment of the present disclosure. In exemplary embodiments of the present disclosure, the first display module 151a may be a touch screen, and the second display module 151b may be e-paper. E-paper can provide high resolution images similar to ordinary ink on paper, wide viewing angles, desirable visual properties, and can maintain an image displayed independently of power.

The first display module 151a can display a color image and receive a touch input. The second display module 151b can display a black-and-white image while consuming less power than the first display module 151a, which may be effectively used to control the operation of the mobile terminal 100. In addition, the mobile terminal 100 may perform the functions of a double-sided display using the first display module 151a, which is disposed on the front case 100A-1 of the mobile terminal 100, and the second display module 151b, which is disposed on the rear case 100A-2 of the mobile terminal 100.

Referring to FIG. 4, when an operation menu is selected in response to a user command (S200), the controller 180 may select the first display module 151a to display a first image corresponding to the selected operation menu (S202) and may select the second display module 151b to display a second image corresponding to the selected operation menu (S204).

Various images may be used as the first and second images according to the type of the selected operation menu.

For example, when the selected operation menu is an image viewing menu, a color image page may be displayed on the first display module 151a, and a black-and-white image page may be displayed on the second display module 151b. When the selected operation menu is a camera album menu, an image page may be displayed on the first display module 151a, and an information page displaying information about the image page may be displayed on the second display module 151b. When the selected operation menu is a schedule menu, a personal schedule page may be displayed on the first display module 151a, and a business schedule page may be displayed on the second display module 151b.

Thus, various images corresponding to the selected operation menu may be displayed on the first and second display modules 151a and 151b, thereby providing the functions of a double-sided display while continuously displaying an image on at least one of the display modules 151a and 151b when power is not provided. In this manner, it is possible to display various menu images corresponding to the selected operation menu on the first and second display modules 151a and 151b.

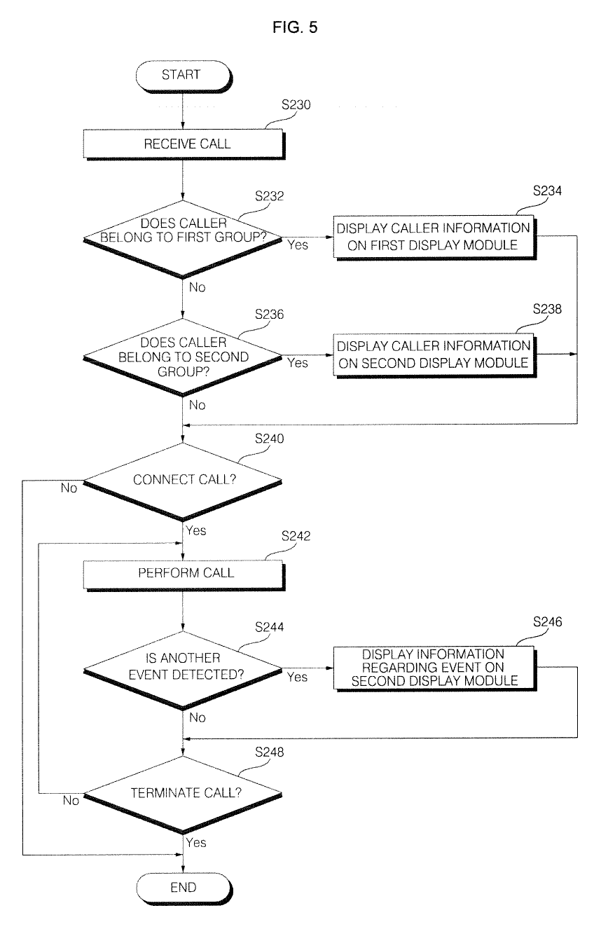

When a menu item is selected from the first or second image (S206), the controller 180 may control an operation corresponding to the selected menu item to be performed (S208). Operations S202 through S208 may be performed repeatedly until the user selects to terminate the operation corresponding to the selected menu item (S210). FIG. 5 illustrates a flowchart of a method of controlling the operation of a mobile terminal according to a second exemplary embodiment of the present disclosure. More specifically, FIG. 5 shows how to control the operation of the mobile terminal 100 using the first and second display modules 151a and 151b when there is an incoming call request.

Referring to FIG. 5, when a first incoming call such as a voice call or a video call is received (S230), the controller 180 may identify the caller of the first incoming call. When the caller of the first incoming call belongs to a first group of callers (S232), the controller 180 may select the first display module 151a to display information regarding the caller of the first incoming call (S234). Alternatively, when the caller of the first incoming call belongs to a second group of callers (S236), the controller 180 may select the second display module 151b to display the information regarding the caller of the first incoming call (S238).

The first and second groups of callers may be pre-programmed in response to a user command. When the caller of the first incoming call belongs to neither the first group nor the second group of callers, the controller 180 may select the first display module 151a to display the information regarding the caller of the first incoming call. When the user chooses to accept the first incoming call (S240), the controller 180 may connect and perform the first incoming call (S242).

When an event is detected during the first incoming call (S244), the controller 180 may select the second display module 151b to display information regarding the event. If the event is a second incoming call, information regarding the caller of the second incoming call may be displayed. In addition, if the event is the receipt of email, the controller 180 may display information regarding the e-mail (S246).

Operations S242 through S246 may be repeatedly performed until the user selects to terminate the first incoming call (S248). In this manner, it is possible to effectively display various sets of information regarding a call by using the first and second display modules 151a and 151b.

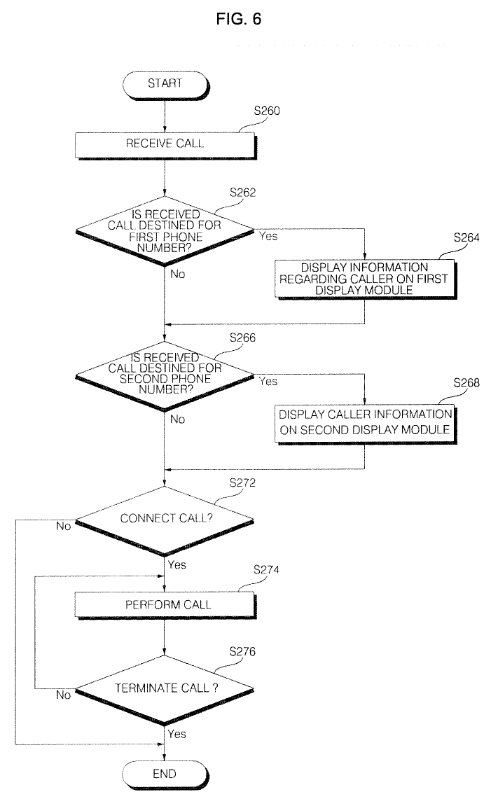

FIG. 6 illustrates a flowchart of a method of controlling the operation of a mobile terminal according to a third exemplary embodiment of the present disclosure. More specifically, FIG. 6 shows how to control the operation of the mobile terminal 100 using the first and second display modules 151a and 151b when the mobile terminal 100 is equipped with more than one user authentication module (such as a SIM or UIM) and thus has two phone numbers, i.e., first and second phone numbers.

Referring to FIG. 6, when a first incoming call such as a voice call or a video call is received (S260), the controller 180 may detect whether the first incoming call requests to connect to the first phone number (S262). When the first incoming call is destined for the first phone number, the controller 180 may select the first display module 151a to display information regarding the caller of the first incoming call (S264). In addition, the controller 180 may detect whether the first incoming call requests to connect to the second phone number (S266). When the first incoming call is destined for the second phone number, the controller 180 may select the second display module 151b to display the information regarding the caller of the first incoming call (S266).

When the mobile terminal 100 is equipped with a plurality of user authentication modules, one of the user authentication modules may be connected to the controller 180 through the interface unit 170. Thus, the controller 180 may determine whether the first incoming call is destined for the first phone number or the second phone number by determining which of the user authentication modules is connected thereto.

When the user chooses to accept the first incoming call (S272), the controller 180 may connect and perform the first incoming call (S274). When a second incoming call is received or an event occurs during the first incoming call, the controller 180 may select the second display module 151b to display information regarding the second incoming call or the event as illustrated in FIG. 5.

When the user chooses to terminate the first incoming call (S276), the method ends. Otherwise, the method call continues (S274). In this manner, it is possible to effectively display information regarding one of the first and second phone numbers using the first and second display modules 151a and 151b.

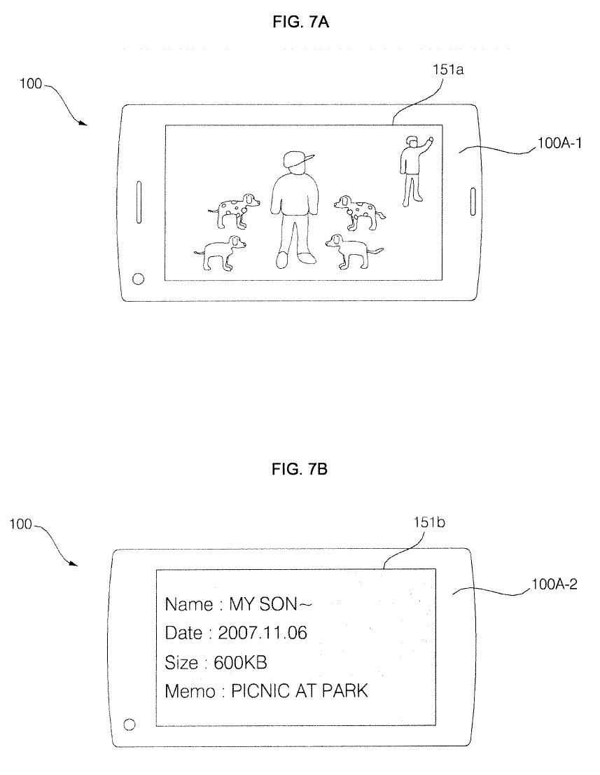

FIGS. 7 through 15 illustrate diagrams for explaining the methods of the first through third exemplary embodiments.

FIG. 7 illustrates a diagram showing how to control the operation of the mobile terminal 100 when a camera album menu for viewing a photo file or a moving-image file is selected. When a camera album menu is selected and a desired photo or moving-image file is selected, an image page corresponding to the selected file may be displayed on the first display module 151a, as shown in FIG. 7A and metadata regarding the image page may be displayed on the second display module 151b, as shown in FIG. 7B. The metadata regarding the image page may include the name of the selected file, the date of creation of the selected file and a memo associated with the selected file.

The metadata regarding the image page may be selectively programmed in advance. In this manner, it is possible to obtain the benefits of displaying an image page on the first display module 151a and metadata regarding the image page on the second display module 151b.

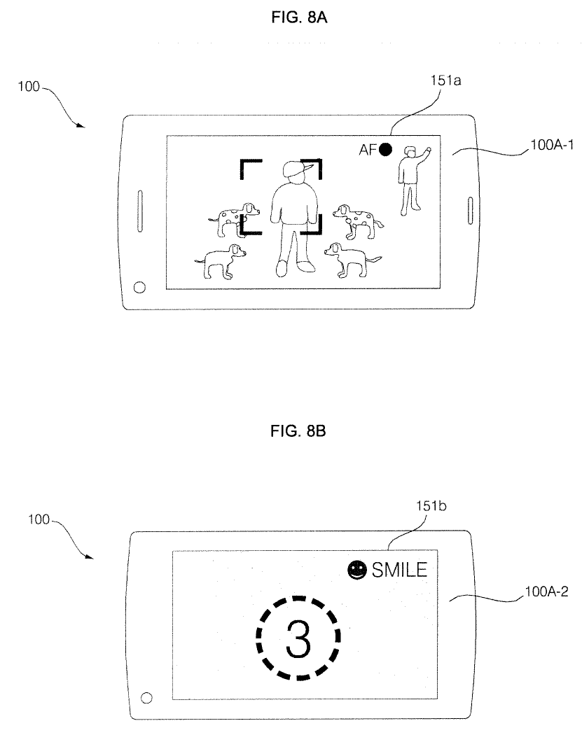

FIG. 8 illustrates a diagram showing how to control the operation of the mobile terminal 100 when a camera menu is selected. When a camera menu is selected, a first image corresponding to a first sub-operation of the selected camera menu may be displayed on the first display module 151a. A second image corresponding to a second sub-operation of the selected camera menu may be displayed on the second display module 151b.

The first sub-operation may be a capture preview page to provide the user a preview of a photograph to be taken, as shown in FIG. 8A. The second sub-operation may be a photograph shoot notice page providing a user notice when a photograph will be taken, as shown in FIG. 8B. In other words, a person to be photographed may easily determine when he or she is to be photographed based on the photograph shoot notice page.

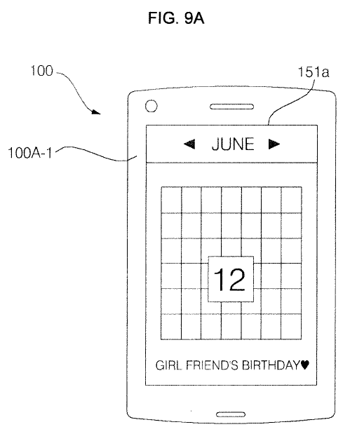

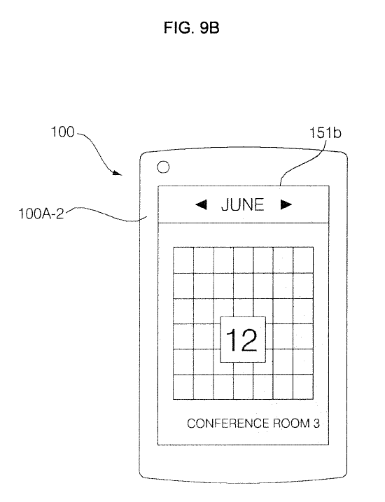

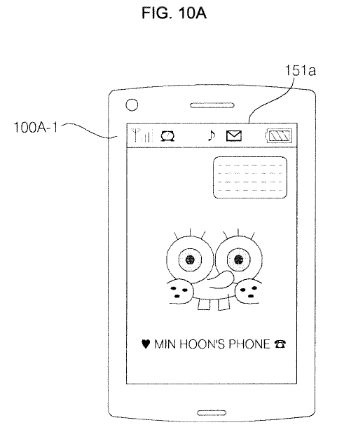

FIG. 9 illustrates a diagram showing how to control the operation of the mobile terminal 100 when a schedule viewing menu is selected. When a schedule viewing menu is selected, a personal schedule page may be displayed on the first display module 151a, as shown in FIG. 9A, and a business schedule page may be displayed on the second display module 151b, as shown in FIG. 9B.

In this manner, it is possible to quickly view various schedule pages at the same time using the first and second display modules 151a and 151b. In addition, when the second display module 151b is an e-paper display, a schedule page likely to be frequently viewed may be displayed on the second display module 151b independent of whether the first display module 151a is placed in a power-save mode.

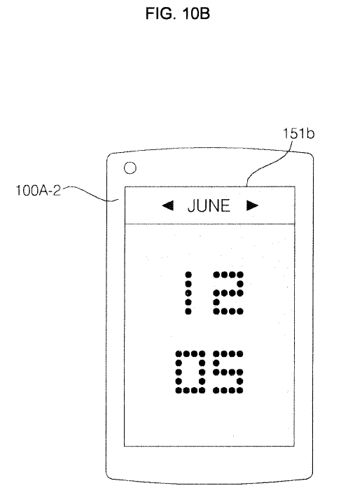

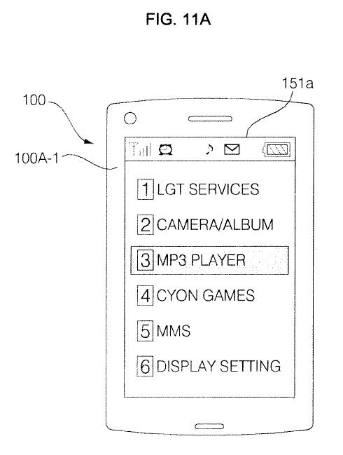

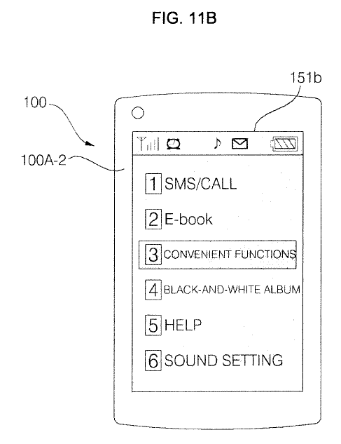

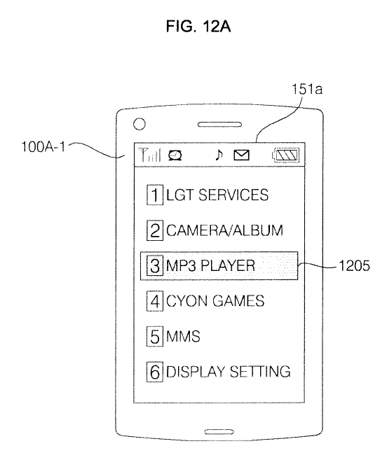

As illustrated in FIG. 10A, an idle screen may be displayed on the first display module 151a. In this case, a date/tine page may be displayed on the second display module 151b as illustrated in FIG. 10B. Alternatively, a page selected in response to a user command may be displayed on the second display module 151b.

The first display module 151a may be e-paper such that the idle screen is displayed independently of power. Therefore, it is possible to display any desired page even when the first display module 151a is placed in a power-save mode and is thus turned off. Referring to FIGS. 11A and 11B, first and second menu pages having different sets of menu operations may be displayed on the first and second display modules 151a and 151b, respectively, in response to a user command. As such, the first and second sets of menu operations are independent of each other. In this manner, it is possible to quickly view a plurality of menu operations by displaying different sets of menu operations on the first and second display modules 151a and 151b disposed at the front and the rear, respectively, of the mobile terminal 100.

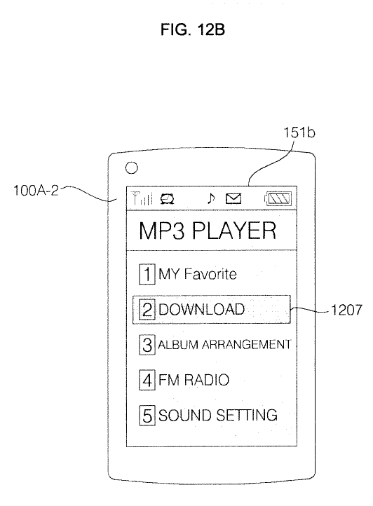

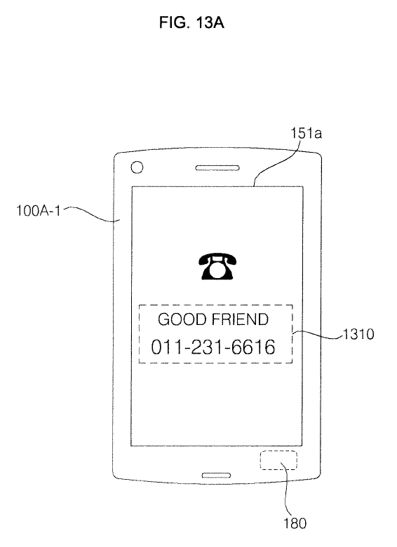

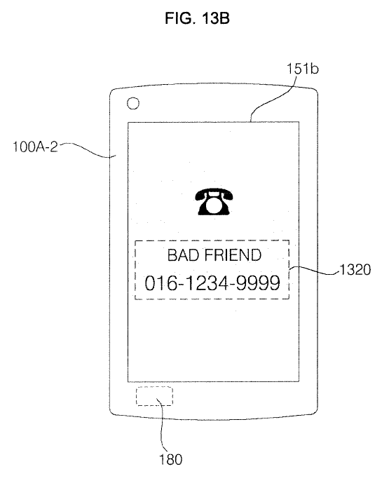

Referring to FIGS. 12A and 12B, a first image corresponding to a set of menu operations may be displayed on the first display module 151a and a second image corresponding to a menu operation selected from the set of menu operations may be displayed on the second display module 151b. For example, a menu page may be displayed on the first display module 151a.

When a menu item, such as an MP3 player application 1207, is selected from the menu page displayed on the first display module 151a, a sub-menu page corresponding to the MP3 player application 1205 may be displayed on the second display module 151b, as shown in FIG. 12B. In this manner, it is possible to quickly choose and execute any desired menu item by displaying a main menu page on the first display module 151a and a sub-menu page corresponding to a menu item selected from the main menu page on the second display module 151b.

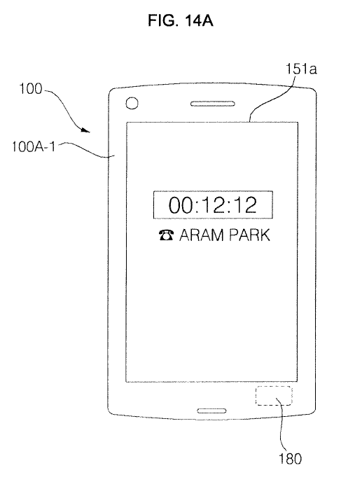

Referring to FIGS. 13A and 13B, the controller 180 may select the first display module 151a to display a first image corresponding to a first group of callers and the second display module 151b to display a second image corresponding to a second group of callers. For example, information regarding a caller classified into a first group 1310 may be displayed on the first display module 151a. Referring to FIG. 13B, information regarding a caller classified into a second group 1320 may be displayed on the second display module 151b.

Additionally, information about a caller may be detected such that selecting the first display module 151a or the second display module 151b identifies the caller. In this manner, it is possible to easily determine what caller group each individual caller belongs to based on whether information regarding a corresponding caller is displayed on the first display module 151a or the second display module 151b.

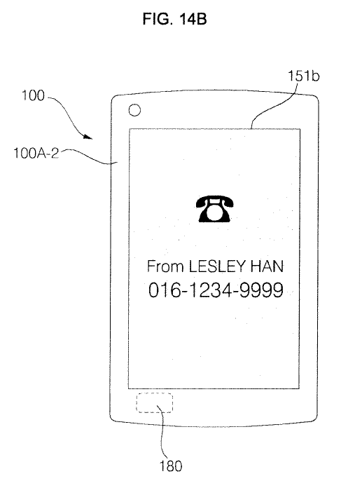

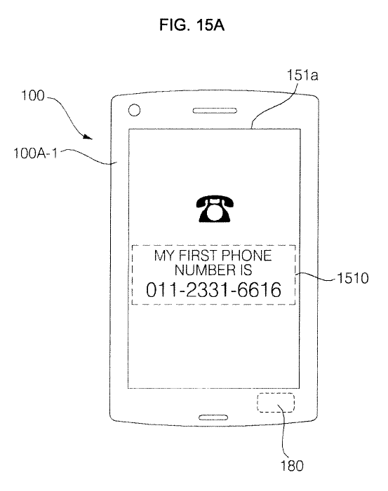

Referring to FIG. 14A, a call screen for a first incoming call may be displayed on the first display module 151a. The controller 180 may select the second display module 151b to display an image corresponding to an incoming call when the mobile terminal is connected to a previous call, as illustrated in FIG. 14B.

For example, when a second incoming call is received during the first incoming call, a call screen for the second incoming call may be displayed on the second display module 151b, as shown in FIG. 14B. Likewise, the controller 180 may select the second display module 151b to display another image corresponding to an event detected when the mobile terminal is connected to a previous call. For example, when the event occurs during the first incoming call, information regarding the event may be displayed on the second display module 151b.

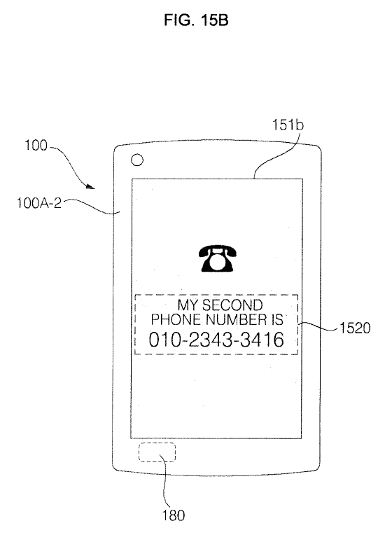

Referring to FIGS. 15A and 15B, the controller 180 may select the first display module 151a to display a first image corresponding to a first incoming call requesting to connect to a first phone number and the second display module 151b to display a second image corresponding to a second incoming call requesting to connect to a second phone number. For example, when the mobile terminal 100 uses two phone numbers, i.e., first and second phone numbers, a first call screen 1510 for the first phone number may be displayed on the first display module 151a. and a second call screen 1520 for the second phone number may be displayed on the second display module 151b. In this manner, it is possible to determine which of the first and second phone numbers each incoming call is destined for based on information regarding a corresponding incoming call being displayed on the first display module 151a or the second display module 151b.

Therefore, it is possible to perform various control operations on the mobile terminal 100 using two display modules having different properties. The mobile terminal according to the present disclosure and the method of controlling the operation of a mobile terminal according to the present disclosure are not restricted to the exemplary embodiments set forth herein. Therefore, variations and combinations of the exemplary embodiments set forth herein may fall within the scope of the present disclosure.

The present disclosure can be realized as code that can be read by a processor (such as a mobile station modem (MSM)) included in a mobile terminal and that can be written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the internet). The computer-readable recording medium can be distributed over a plurality of computer systems connected to a network so that computer-readable code is written thereto and executed therefrom in a decentralized manner. Functional programs, code, and code segments needed for realizing the present disclosure can be easily construed by one of ordinary skill in the art.

According to the present disclosure, it is possible to perform the functions of a double-sided display by providing two display modules at the front or rear of a mobile terminal. In addition, it is possible to reduce the power consumption of a mobile terminal and maintain the display of data even in a power-save mode or in case of power cut-off by using a touch screen and e-paper, which consumes less power than a touch screen and can continuously display an image even when power is cut off.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

What is claimed is:

1. A method of controlling a mobile terminal, the method comprising:
selecting a menu operation of the mobile terminal; and
selecting between a first display module provided on a first side of the mobile terminal and a second display module provided on a second side of the mobile terminal to display an image corresponding to the selected menu operation.

2. The method of claim 1, further comprising:
displaying a first image corresponding to a first operation on the first display module;
displaying a second image corresponding to a second operation on the second display module; and
performing the second operation while the first display module is idle.

3. The method of claim 2, wherein the idle first display module comprises an electronic paper display such that the idle first display module displays the first image independent of power.

4. The method of claim 1, further comprising:
displaying a first image corresponding to a first sub-operation of the selected menu operation on the first display module;
displaying a second image corresponding to a second sub-operation of the selected menu operation on the second display module; and
performing the first sub-operation and the second sub-operation.

5. The method of claim 4, wherein the selected menu operation is a camera menu, the first sub-operation is a capture preview page and the second sub-operation is a photograph shoot notice page.

6. The method of claim 1, further comprising displaying a first image corresponding to the selected menu operation on the first display module.

7. The method of claim 6, further comprising displaying a second image corresponding to the selected menu operation on the second display module.

8. The method of claim 7, wherein the displayed second image corresponds to a set of metadata of the first image.

9. The method of claim 7, wherein the displayed first image corresponds to a first subset of the selected menu operation and the displayed second image corresponds to a second subset of the selected menu operation.

10. The method of claim 9, wherein the selected menu operation is a schedule page, the first subset is a personal schedule page and the second subset is a business schedule page.

11. The method of claim 7, wherein the displayed first image corresponds to a set of menu operations and the displayed second image corresponds to a menu operation selected from the set of menu operations.

12. The method of claim 7, wherein the displayed first image corresponds to a first set of menu operations and the displayed second image corresponds to a second set of menu operations such that the first set is independent of the second set.

13. A mobile terminal, comprising:
a first display module provided on a first side of the mobile terminal;
a second display module provided on a second side of the mobile terminal; and
a controller configured to select between the first display module and the second display module to display a first image corresponding to a selected operation.

14. The mobile terminal of claim 13, wherein the first display module comprises a touch screen display and the second display module comprises an electronic paper display such that the second display module displays the first image independent of power.

15. The mobile terminal of claim 13, further comprising a wireless communication device configured to receive an incoming call requesting to connect to the mobile terminal.

16. The mobile terminal of claim 15, further comprising detecting information about a caller of the incoming call such that selecting between the first display module and the second display module identifies the caller.

17. The mobile terminal of claim 16, wherein the controller selects the first display module to display the first image corresponding to a first group of callers and the second display module to display a second image corresponding to a second group of callers.

18. The mobile terminal of claim 15, wherein the controller selects the first display module to display the first image corresponding to a first incoming call requesting to connect to a first phone number and selects the second display module to display a second image corresponding to a second incoming call requesting to connect to a second phone number.

19. The mobile terminal of claim 15, wherein the controller selects the second display module to display a second image corresponding to an incoming call when the mobile terminal is connected to a previous call.

20. The mobile terminal of claim 15, wherein the controller selects the second display module to display a second image corresponding to an event detected when the mobile terminal is connected to a previous call.

21. A method of controlling a mobile terminal provided with multiple display modules, the method comprising:
receiving an incoming call;
detecting information about the incoming call;
detecting whether the incoming call belongs to a first group of callers or a second group of callers according to the detected information;
selecting a first display module to display a first image corresponding to the detected information when the first group is detected; and
selecting a second display module to display a second image corresponding to the detected information when the second group is detected.

22. A method of controlling a mobile terminal provided with multiple display modules, the method comprising:
receiving an incoming call;
detecting information about the incoming call;
detecting whether the incoming call requests to connect to a first phone number or to a second phone number of the mobile terminal;
selecting a first display module to display a first image corresponding to the detected information when the first phone number is requested; and
selecting a second display module to display a second image corresponding to the detected information when the second phone number is requested.
